(19) United States
(12) Patent Application Publication
(10) Pub. No.: US 2007/0291625 A1
(43) Pub. Date: Dec. 20, 2007

(54) Magneto-optical storage medium

(75) Inventors: Robert Frans Maria Hendriks, Eindhoven (NL); Gavin Nicholas Phillips, Eindhoven (NL); Jacobus Josephus Maria Ruigrok, Eindhoven (NL); Frank Cornelis Penning, Eindhoven (NL); Ferry Zijp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/580,500

(22) PCT Filed: Nov. 18, 2004
(86) PCT No.: PCT/IB04/03792

§ 371 Date: May 23, 2006

(30) Foreign Application Priority Data
Nov. 28, 2003 (EP) 03300233.8

(51) Int. Cl. G11B 7/24

(52) U.S. Cl. 369/275.2; 369/13.02

(57) ABSTRACT

The present invention relates to a storage medium (10) comprising an information layer (11) including transparent and non-transparent areas in which the information is stored, and a magnetizable layer (12) intended to contain at least one magnetized area, which is temporarily created when a light spot is transmitted by a corresponding transparent area of the information layer. The present invention also relates to a reading device for reading information on such a storage medium (10). Said reading device comprises an optical element (23) for generating an array of light spots from an input light beam (21), a light spot being intended to temporarily create the magnetized area in the magnetizable layer (12) when passing through the corresponding transparent area of the information layer (11), and a magnetic sensor (24) comprising an array of sensor elements for detecting the at least one magnetized areas.

### FIELD OF THE INVENTION

The present invention relates a storage medium comprising an information layer intended to store information.

The present invention also relates to a device for reading information on such a storage medium.

This invention may be used in, for example, the field of optical data storage.

### BACKGROUND OF THE INVENTION

The use of optical storage is nowadays widespread for content distribution, for example in storage systems based on the DVD (Digital Versatile Disc) standards. An advantage of conventional optical storage systems is that the storage media are relatively easy and cheap to replicate.

However, such conventional optical storage systems require a CCD (charge-coupled device) or a CMOS (complimentary metal-oxide semiconductor) image sensor for the read out of data from the information layer. Said sensor is one of the most expensive parts of the conventional optical storage systems.

### SUMMARY OF THE INVENTION

It is an object of the invention to propose a less expensive storage system than the one of the prior art.

To this end, the storage medium in accordance with the invention is characterized in that it comprises:
an information layer including transparent and non-transparent areas in which the information is stored, and
a magnetizable layer intended to contain at least one magnetized area, which is temporarily created when a light spot is transmitted by a corresponding transparent area of the information layer.

The present invention also relates to a device for reading information from such a storage medium, said device comprising:
an optical element for generating an array of light spots from an input light beam, a light spot being intended to temporarily create the magnetized area in the magnetizable layer when passing through the corresponding transparent area of the information layer, and
a magnetic sensor comprising an array of sensor elements for detecting the at least one magnetized area.

Thus, compared to a conventional optical storage system, the storage system in accordance with the invention is simpler and cheaper, as a magnetic sensor is used instead of a CMOS or a CCD image sensor.

According to an embodiment of the invention, the storage medium further comprises a separation layer such that the magnetized area is greater than the corresponding transparent area. As a consequence, the magnetic sensor can have a lower resolution than the resolution of the information layer thanks to such a magnifying effect.

According to another embodiment of the invention, the information layer is a conventional information layer including transparent and non-transparent areas in which the information is stored, and the corresponding reading device comprises:
an optical element for generating an array of light spots from an input light beam,
a magnetizable layer intended to contain at least one magnetized area, which is temporarily created when a light spot is transmitted by a corresponding transparent area of the information layer, and
a magnetic sensor comprising an array of sensor elements for detecting the at least one magnetized area.

In this case, the magnetizable layer is part of the reading device and no more part of the storage medium, making the storage system even more cost-effective.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 shows a storage medium in accordance with the invention,

FIG. 2 shows a reading device in accordance with the invention for reading information on the storage medium,

FIG. 3 depicts a detailed view of components dedicated to the macro-cell scanning used in the storage system according to the invention, and

FIG. 4 illustrates the principle of the macro-cell scanning in accordance with the invention.

### DETAILED DESCRIPTION OF THE INVENTION

Storage systems alternative to conventional optical storage systems are currently being developed. As it is expected that solid-state media will not become cheap enough for content distribution, it is believed that a new dedicated technology will replace the conventional optical storage in the future.

The international patent application no IB03/04312 (attorney's docket PHNL021405) discloses a magnetic storage system. Said system is, for example, a Magnetic Read-Only Memory MROM system. Such a storage system comprises a patterned magnetic storage medium and a reading device. The storage medium is a card comprising an information layer that is provided with a pattern of an electromagnetic material constituting an array of bits. The presence or absence of said electromagnetic material in the information layer represents a value of a bit. The corresponding reading device comprises an interface surface for cooperating with the information layer, which interface surface is provided with an array of electromagnetic sensor elements that are sensitive to the presence of the electromagnetic material, and alignment means for positioning the sensor elements near the bit locations within a near-field working distance between a sensor element and the corresponding bit.

However, due to the small size of the bits, the separation between the sensor and the information layer must be small. In other words, the separation between the information layer and the sensor should be the same as the bit size, i.e. lower than 500 nm. This makes the system very sensitive to contamination. To cope with this problem, a new storage system is here proposed.

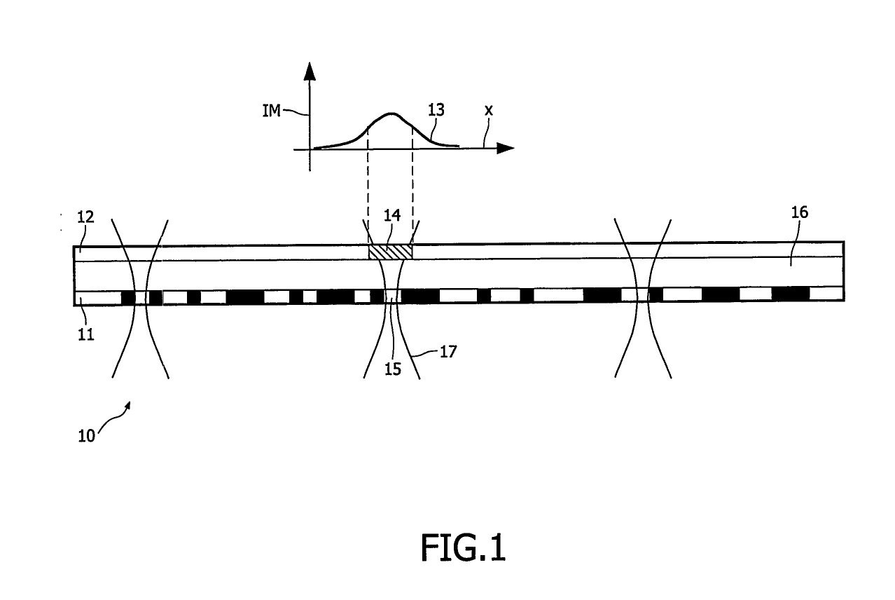

FIG. 1 is a detailed view of a storage medium 10 in accordance with the invention. Said storage medium comprises an information layer 11, a magnetizable layer 12 and a separation layer 16 between them.

The information is coded in the information layer 11. For example, the information layer is made of a polymer material and is intended to store binary data organized according to an array of data bits. The states of binary data stored on the information carrier are represented by transparent or semi-transparent areas and non-transparent areas (i.e. light absorbing areas). The information layer is replicated or printed according to a principle known to a person skilled in the art.

The information layer comprises, for example, an array of data bits arranged in macro-cells, a macro-cell being intended to be read by a single light spot as it will be described in more detail hereinafter.

The technology used for the magnetizable layer is, for example, the same technology as the one used in the MAMMOS (for Magnetic Amplifying Magneto-Optical System) super-resolution system. Said technology is described in H. Awano et al., Appl. Phys. Lett. 69 27 (1996) 4257-4259.

The magnetizable layer 12 comprises a ferrimagnetic material such that the magnetization at room temperature is approximately zero, while for higher temperatures the layer becomes magnetized. Such a material is, for example, a ferrimagnetic rare-earth-transition metal (RE-TM) alloy such as GdFeCo. When a data bit of the information layer is transparent the transmitted light spot 17 heats up the magnetizable layer and induces a magnetization. The thermal profile is depicted by curve 13 showing the evolution of the magnetization intensity IM as a function of the longitudinal axis x. The resulting magnetization is illustrated by the magnetized area 14. It is to be noted that the diffraction of the light causes the light spot 17 at the magnetizable layer to be larger than the corresponding transparent area 15 of the information layer. Therefore, the size of the magnetized area 14 in the magnetizable layer is larger than the size of the corresponding transparent area 15 of the information layer 11.

The magnetized areas induced in the magnetizable layer by the incident light may possess in-plane or perpendicular magnetic anisotropy. A magnetizable layer in which magnetized areas have a perpendicular magnetization is generally preferred.

The separation layer 16 is made of a material adapted to transmit light, for example a transparent or semi-transparent polymer. The thickness of the separation layer depends on the desired magnification (i.e. the ratio of the size of the magnetized area to the size of the transparent area) to be achieved.

It is to be noted that the separation layer is not essential to the invention and that the information layer can be in contact with the magnetizable layer, making the size of the magnetized area substantially the same as the size of the transparent area.

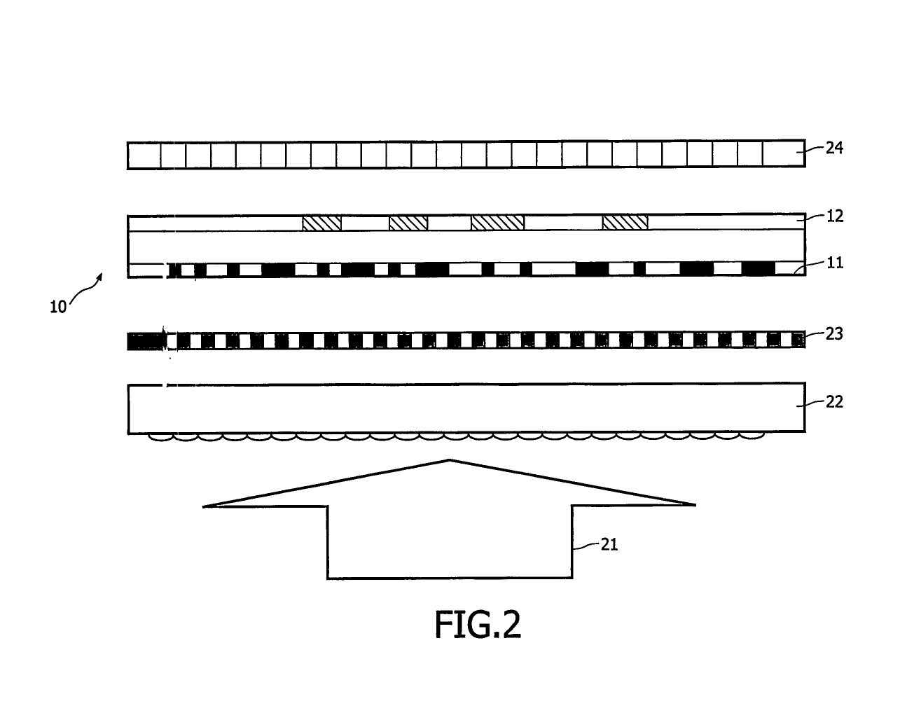

FIG. 2 is a schematic drawing of a reading device in accordance with the invention for reading data stored on the storage medium.

The reading device comprises an optical element 23 for generating an array of light spots from a coherent input light beam 21 delivered by a light source, said array of light spots being intended to scan the storage medium 10. This feature enables a parallel read out of data. The input light beam 21 can be realized, for example, by a waveguide for expanding an input laser beam.

According to an embodiment of the invention (not represented), the optical element corresponds to a two-dimensional array of micro-lenses. The array of micro-lenses is placed parallel and distant from the storage medium so that light spots are focused on said storage medium. The numerical aperture and quality of the micro-lenses determines the size of the light spots.

According to another embodiment of the invention, the optical element corresponds to a two-dimensional array of apertures. The apertures correspond, for example, to circular holes having a diameter of 1 μm or much smaller. In this case, the array of light spots is generated by the array of apertures in exploiting the Talbot effect which is a diffraction phenomenon working as follows. When a number of coherent light emitters of the same wavelength, such as the input light beam, are applied to an object having a periodic diffractive structure, such as the array of apertures, the diffracted lights recombines into identical images of the emitters at a plane located at a predictable distance z0 from the diffracting structure. This distance z0 is known as the Talbot distance. The Talbot distance z0 is given by the relation z0=2.n.d²/λ, where d is the periodic spacing of the light emitters, x is the wavelength of the input light beam, and n is the refractive index of the propagation space. More generally, re-imaging takes place at other distances z(m) spaced further from the emitters and which are a multiple of the Talbot distance z such that z(m)=2.n.m.d²/λ, where m is an integer. Such a re-imaging also takes place for m=½+an integer, but here the image is shifted over half a period. The re-imaging also takes place for m=¼+an integer, and for m=¾+an integer, but the image has a doubled frequency which means that the periodicity of the apertures is halved with respect to that of the array of apertures.

Exploiting the Talbot effect allows generating an array of light spots of high quality at a relatively large distance from the array of apertures (a few hundreds of μm, expressed by z(m)), without the need of optical lenses. This allows inserting for example a cover layer between the array of aperture and the information layer for preventing the latter from contamination (e.g. dust, finger prints). Moreover, this facilitates the implementation and allows increasing in a cost-effective manner, compared to the use of an array of micro-lenses, the density of light spots which are applied to the information layer.

An issue is that in current MAMMOS systems the laser powers in a single spot are 5 to 8 mW for writing (peak value, for pulsed operation the average power drops down to 2 to 3 mW), and 1 to 2 mW for reading. For a parallel readout system as proposed here, the total power is distributed over all parallel light spots, and therefore the laser power per spot is limited.

The reading device further comprises a phase-modulator 22 placed in the light path of the input light beam 21. A non-mechanical scanning can thus be achieved by applying a phase profile defined by the phase-modulator 22 to the input light beam 21, and by varying the phase profile. The phase-modulator 22 varies the phase of the input light beam 21 with respect to the lateral distance. It is noted that the phase-modulator 22 can also be placed between the optical element 23 and the storage medium 10.

When the phase-modulator 22 acts so as the phase φ(x) varies in a linear way with respect to the lateral position x, this leads to a lateral shift Ax of the array of light spots along the lateral axis x. The phase φ(x) is defined as follows:

$$ϕ ( x ) = \frac{2 π}{b} \cdot \frac{x}{λ} \qquad ( 1 )$$

where λ is the wavelength of the input light beam 21 and b is a variable parameter.

If a phase profile as defined by equation (1) is performed by the phase-modulator 22, the lateral shift x of the array of light spots is defined as follows:
Δx=b.Z (2)

where Z is a fixed value corresponding advantageously to the Talbot distance z0, to a multiple, or to a sub-multiple of said Talbot distance z0.

The parameter b allows modifying the linearity factor of the phase profile in view of changing the lateral shift Δx. For each value of the parameter b, a different phase profile is defined. A variation of the parameter b results as a consequence in a spot shift in x.

For scanning all the surface of the storage medium 10, each macro-cell of the information layer must be scanned by a light spot of the array of spots. The scanning of a macro-cell thus corresponds to a two-dimensional scanning. This two-dimensional scanning is performed in defining simultaneously a linear phase modulation according to a first axis x and a second axis y, the defined phase profile resulting from a linear combination of a linear phase profile according to the x axis and a linear phase profile according to the y axis. The macro-cell scanning will be described in more detail hereinafter.

The phase-modulator 22 comprises advantageously controllable liquid crystal (LC) cells associated with an array of micro-lenses. For example, pixilated linear nematic LC cells are used such that each aperture of the array of apertures has its own LC cell and can be given its own phase φ(x). Thus, the phase-modulator corresponds to a two-dimensional array of LC cells. Nematic substances can be aligned by electric and magnetic fields, resulting in a phase change.

The array of light spots generated by the optical element 23 is applied to the information layer 11 of the storage medium 10. When the information layer is transparent, the transmitted light heats up the magnetizable layer according to the thermal profile illustrated by curve 13, which causes the magnetization of a relatively large magnetized area in the magnetizable layer as shown in FIG. 1.

The reading device in accordance with the invention finally comprises a magnetic sensor 24 comprising an array of sensor elements for reading the magnetized areas. Said magnetic sensor is, for example, a TMR (for tunnel magneto-resistance) sensor or a GMR (for giant magneto-resistance) sensor.

With such sensors, the read-out is done by a resistance measurement which relies on a magneto-resistance phenomenon detected in a multilayer stack. The giant magneto-resistance GMR effect has a large magneto-resistance effect (5 to 15%), and therefore a high output signal. The magnetic tunnel junctions use a large tunnel magneto-resistance TMR effect, and resistance changes up to 50% have been shown.

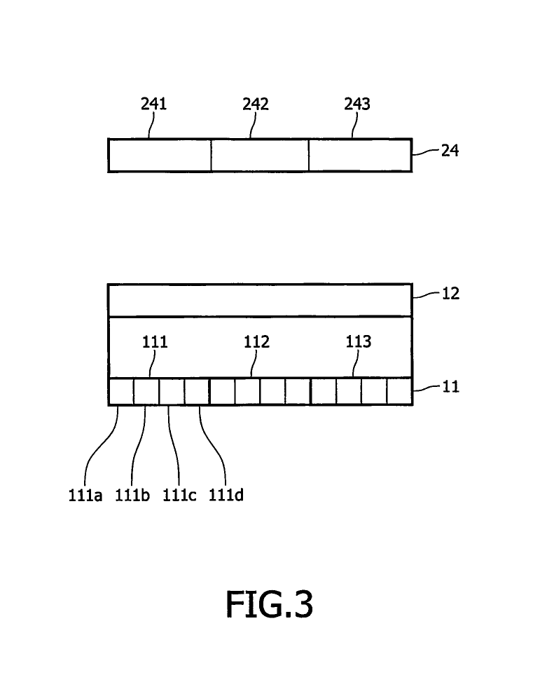

FIG. 3 shows a detailed view of components dedicated to the macro-cell scanning used in the storage system according to the invention.

It depicts the magnetic sensor 24 which is intended to detect data from magnetized areas generated in the expansion layer 12 in response to a heating caused by a light transmitted by a transparent area of the information layer 11. The sensor comprises sensor elements 241 to 243, the number of sensors represented in FIG. 3 being limited for facilitating the understanding. The information layer is organized in macro cells. Each macro-cell comprises a set of elementary data. For example, a macro cell 111 comprises 4 bits 111a to 111d.

In particular, the sensor element 241 is intended to detect data stored on the macro cell 11 of the information layer, the sensor element 242 is intended to detect data stored on the macro cell 112, and the sensor element 243 is intended to detect data stored on the macro cell 113. In this embodiment, one sensor element is intended to detect a data of a macro cell, each bit of said macro cell being successively read by a single light spot generated by the optical element 23.

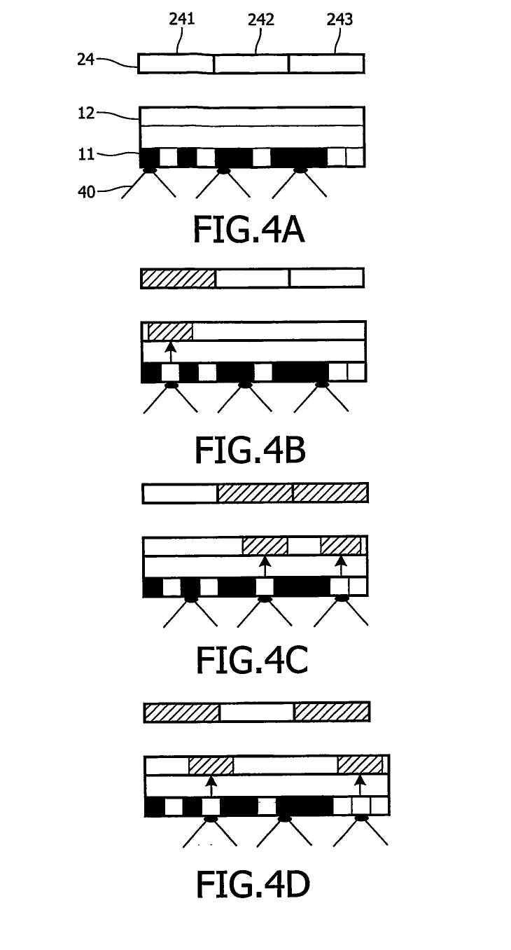

FIG. 4 illustrates a non-limitative way of doing the macro-cell scanning of the storage medium.

Data stored on the information layer 11 have two states indicated either by a black area (i.e. non-transparent) or white area (i.e. semi-transparent or transparent). For example, a black area corresponds to a “0” binary state while a white area corresponds to a “1” binary state.

When a sensor element of the sensor 24 detects a magnetized area in the magnetizable layer 12 (i.e. said magnetizable layer is locally illuminated by an output light beam transmitted by a transparent area of the information layer 11) the magnetized area and the sensor element are represented by a crosshatched area. In that case, the sensor element delivers an electric output signal having a first state. On the contrary, when a sensor element of the sensor 24 does not detect a magnetized area in the magnetizable layer 12 as said magnetizable layer is not locally illuminated, the sensor element is represented by a white area. In that case, the sensor delivers an electric output signal having a second state.

In the example of FIG. 4, each macro cell comprises four bits, and a single light spot is applied simultaneously to each macro cell. The scanning of the information layer 11 by the light spots 40 is performed, for example, from left to right, with an incremental lateral displacement which equals the distance between two bits.

In position A, all the light spots are applied to non-transparent areas so that the sensors elements of the magnetic sensor are in the second state.

In position B, after a first displacement of the light spots to the right, the light spot to the left side is applied to a transparent area so that a magnetized area is created in the magnetizable layer and that the corresponding sensor element is in the first state. The two other light spots are applied to non-transparent areas so that the two corresponding sensors elements are in the second state.

In position C, after a second displacement of the light spots to the right, the light spot to the left side is applied to a non-transparent area so that the corresponding sensor element is in the second state, while the two other light spots are applied to transparent areas so that the two corresponding sensor elements are in the first state.

In position D, after a third displacement of the light spots to the right, the central light spot is applied to a non-transparent area so that the corresponding sensor element is in the second state, while the two other light spots are applied to transparent areas so that the two corresponding sensor elements are in the first state.

The macro cell scanning of the information layer is complete when the light spots have been applied to all bits of a macro cell facing a sensor element of the sensor. Since the light spots applied to the information layer form a two-dimensional array, a macro cell facing a sensor element of the sensor is read successively lines by lines, and bits by bits for a given line of bits. It implies a two-dimensional scanning of the information layer.

It is to be noted that a magnetized area does not always face exactly the corresponding sensor element and can sometimes be in the detection area of another sensor element. This is normally not a problem as a sensor element is adapted to detect a magnetization higher than a predetermined threshold, said threshold being such that the sensor element facing a given macro cell is activated for each transparent bit of the given macro cell and is not activated for transparent bits of macro cells neighboring the given macro cell. So the detection threshold of a sensor element is tuned to detect magnetized areas corresponding to bits of a macro cell facing said sensor element and not to detect magnetized areas corresponding to bits of macro cells other than the facing one.

Alternatively, some space can be inserted between macro-cells and corresponding sensor elements. Moreover, a certain probability on a bit-detection error can be accepted and repaired by an appropriate error-correction scheme.

It is also to be noted that the size of sensor element can be smaller than the magnetized area, which allows misalignment between the medium and the sensor. The magnetic sensor can be sensitive to a parallel or perpendicular component of the magnetization depending on the magnetization direction in the magnetized areas.

In an alternative embodiment of the invention, the magnetizable layer is physically separated from the data storage medium and embedded in the reading device. In this case, the storage medium is a conventional medium comprising an information layer and the reading device comprises the magnetizable layer. The magnetizable layer is either a separate component, or is integrated within the magnetic sensor. Such an embodiment may deliver even further enhanced robustness against contamination.

Compared to a MROM system, the present invention is less sensitive to contamination, as the separation between the information layer and the sensor is of the order of the size of the magnetized area, instead of the original bit. In other words, the magnetizable layer allows increasing the separation between sensor and information layer.

Compared to an optical system, the present invention is simpler and cheaper as a magnetic sensor can be used, instead of a CMOS or CCD image sensor. Furthermore, no optics is needed to image the information layer onto the sensor.

The information on the storage media can be replicated, making this storage system suitable for content distribution.

Any reference sign in the following claims should not be construed as limiting the claim. It will be obvious that the use of the verb “to comprise” and its conjugations do not exclude the presence of any other steps or elements besides those defined in any claim. The word “a” or “an” preceding an element or step does not exclude the presence of a plurality of such elements or steps.

1. A storage medium (10) comprising:
an information layer (11) including transparent and non-transparent areas in which the information is stored, and
a magnetizable layer (12) intended to contain at least one magnetized area (14), which is temporarily created when a light spot (17) is transmitted by a corresponding transparent area (15) of the information layer.

2. A storage medium (10) as claimed in claim 1, further comprises a separation layer (16) such that said magnetized area (14) is greater than the corresponding transparent area (15).

3. A storage medium (10) as claimed in claim 1, wherein the information layer (11) comprises an array of data bit arranged in macro-cells, each macro-cell being intended to be read by a single light spot.

4. A storage medium (10) as claimed in claim 1, wherein the magnetizable layer (14) is made of a ferrimagnetic material such that magnetization of said material at room temperature is approximately zero, while for higher temperatures said material becomes magnetized.

5. A reading device for reading information from a storage medium (10) as claimed in claim 1, said reading device comprising:
an optical element (23) for generating an array of light spots from an input light beam (21), a light spot (17) being intended to temporarily create the magnetized area (14) in the magnetizable layer (12) when passing through the corresponding transparent area (15) of the information layer (11), and
a magnetic sensor (24) comprising an array of sensor elements for detecting the at least one magnetized area.

6. A reading device as claimed in claim 5, further comprising a phase-modulator (22) for scanning the storage medium by applying a phase profile to the input light beam (21) and by varying the phase profile.

7. A reading device as claimed in claim 6, wherein the phase-modulator (22) is placed in the light path of the input light beam 21.

8. A reading device as claimed in claim 6, wherein the phase-modulator (22) is placed between the optical element (23) and the storage medium (10).

9. A reading device as claimed in claim 5, wherein the magnetic sensor is a tunnel magneto-resistance sensor or a giant magneto-resistance sensor.

10. A reading device for reading information from a storage medium, said storage medium comprising an information layer including transparent and non-transparent areas in which the information is stored, said reading device comprising:
an optical element (23) for generating an array of light spots from an input light beam (21),
a magnetizable layer intended to contain at least one magnetized area, which is temporarily created when a light spot is transmitted by a corresponding transparent area of the information layer, and
a magnetic sensor (24) comprising an array of sensor elements for detecting the at least one magnetized area.
